(19) United States
(12) Patent Application Publication
(10) Pub. No.: US 2026/0211932 A1
(43) Pub. Date: Jul. 23, 2026

(54) FREQUENCY-BASED CONTEXT DATA RETRIEVAL

(71) Applicant: Dell Products L.P., Round Rock, TX (US)

(72) Inventors: OFIR EZRIELEV, Be'er Sheva (IL); LEV MAKLER, Be'er Sheva (IL); YEHONATAN COHEN, Ashdod (IL)

(21) Appl. No.: 19/034,948

(22) Filed: Jan. 23, 2025

(51) Int. Cl. G06F 16/35; G06F 16/36

(52) U.S. Cl. CPC G06F 16/35; G06F 16/367

(57) ABSTRACT

Methods and systems for managing operation of a data processing system are disclosed. A prompt for processing by a trained generative machine-learning model may be obtained. A type of retrieval process for the prompt may be identified based on a classification for the prompt. The classification for the prompt may be based on a likelihood of a search of a data source with respect to the prompt returning information regarding an entity indicated by the prompt. The type of retrieval process may be performed to obtain context data that meets sufficiency criteria (e.g., a minimum level of content of the context data with respect to ontology definitions). A response may be obtained from the trained generative machine-learning model using the prompt and the context data. The response may be used to provision desired computer-implemented services.

### FIELD

Embodiments disclosed herein relate generally to managing data processing systems. More particularly, embodiments disclosed herein relate to systems and methods to manage operation of the data processing systems using inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with an embodiment.

FIGS. 2A-2C show data flow diagrams in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of data processing systems that may provide computer-implemented services. The computer-implemented services may be provided using inference models (e.g., artificial intelligence models). The inference models may be used to generate inferences regarding operation of the data processing systems, and the inferences may be used in downstream processes to increase a likelihood of desired operation of the data processing systems. For example, the inference models may be trained to infer information regarding occurrences of security events (e.g., security threats) to the data processing systems based on ingest data, and the operation of the data processing systems may be updated to mitigate (e.g., prevent) negative outcomes associated with the security events.

However, a quality (e.g., reliability) of the inferences used to manage the operation of the data processing systems may depend on a quality (e.g., informational content) of the ingest data provided to the (trained) inference models to obtain the inferences. For example, the ingest data may include a prompt (e.g., input from a downstream consumer of the inferences). If the informational content of the prompt is limited and/or ambiguous, then the ingest data to the inference model may be inadequate for generating an inference of expected quality.

To increase a likelihood of generating an inference of expected quality, a retrieval-augmented generation process may be implemented. During the retrieval-augmented generation process, context data (e.g., additional information regarding terms such as words and/or phrases in the prompt) may be retrieved from a trusted knowledge base. The context data may then be used to increase the informational content of the ingest data provided to the inference models to generate the inference. However, due to limitations of the retrieval process, the context data may be insufficient to generate expected quality ingest data (e.g., ingest data with adequate informational content).

For example, the prompt may include terms that have special meaning (e.g., different than a dictionary meaning) and/or the prompt may be provided with respect to an entity (e.g., the prompt may indicate that a desired response from the inference model should be limited to information related to the indicated entity, and not relating to a different entity). The context data obtained during the retrieval process may not sufficiently contextualize each of the special terms, and/or a portion of the retrieved context data may not be relevant to the entity (e.g., the trusted knowledge base may include portions of context data relevant to different entities).

Thus, to increase a likelihood of providing expected quality ingest data to the inference models, a context data identification process may be performed iteratively to obtain context data relevant to the entity until sufficiency criteria for the context data is met. To do so, an ontology for use of the inference models may be defined. The ontology may include ontology definitions that specify a list of ontology terms (e.g., words and/or phrases) that have been designated as having a higher degree of meaning by an operator of the inference models than degrees of meaning of other terms. During the context data identification process, the prompt may be analyzed to identify instances of the ontology terms present in the prompt, and the prompt may be classified based on information regarding an entity indicated by the prompt.

Based on the classification for the prompt, a type of retrieval process may be identified for performance during the context data identification process. The type of retrieval process may include a retrieval process to obtain context data associated with the identified ontology terms, and a filtering process to obtain context data relevant to the entity. The retrieval process and the filtering process may be ordered in a manner that improves performance of the context data identification process (e.g., reduces consumption of resources, reduces computational time).

By doing so, context data obtained during context data identification processes (e.g., retrieval processes) may be more likely to be sufficient for improving a quality of the ingest data to the inference models, thereby improving a quality of the inferences used to manage operation of the data processing systems.

In an embodiment, a method for managing operation of a data processing system is provided. The method may include: obtaining a prompt for processing by a trained generative machine-learning model; identifying a type of retrieval process for the prompt based on a classification for the prompt, the classification for the prompt being based on a likelihood of a search of a data source with respect to the prompt returning information regarding an entity indicated by the prompt; performing the type of retrieval process for the prompt to obtain context data that meets sufficiency criteria, the sufficiency criteria specifying a minimum level of content of the context data with respect to ontology definitions; obtaining a response from the trained generative machine-learning model using the prompt and the context data; and, using the response to provision desired computer-implemented services.

Identifying the type of retrieval process may include: identifying the entity indicated by the prompt; obtaining an appearance frequency for the entity with respect to chunks of data of the data source; and, comparing the appearance frequency to a threshold to classify the prompt. The entity, as indicated by the prompt, may have a particularized meaning to a provider of the prompt, and the prompt may indicate that the response should be provided with respect to the entity.

When the classification is a first classification, performing the type of retrieval process may include performing a retrieval process using the data source to obtain raw context data, and filtering the raw context data based on the entity to obtain the context data. When the classification is a second classification, performing the type of retrieval process may include filtering the chunks of data of the data source based on the entity to obtain a filtered data source, and performing a retrieval process using the filtered data source to obtain the context data.

The search of the data source with respect to the prompt may include a similarity-based search of chunks of data of the data source.

Performing the type of retrieval process may include: making a determination regarding whether the context data meets the sufficiency criteria, and, in a first instance of the determination where the context data does not meet the sufficiency criteria: identifying at least one instance of an ontology term of the ontology definitions in the prompt for which the context data does not meet the sufficiency criteria; and, performing an additional retrieval process of the type of retrieval process for the prompt using a revised query that is based on at least the ontology term to obtain additional context data.

The ontology definitions may include a list of ontology terms, and the ontology terms may be words and/or phrases that have been designated as having a higher degree of meaning by an operator of the trained generative machine-learning model than other words and/or phrases not designated as having the higher degree of meaning by the operator.

The data source may be designated as a source of true data by an operator of the trained generative machine-learning model, and the data source may include a number of chunks of data that are each tagged to associate each of the number of chunks of data with the ontology terms.

Using the response to provision the desired computer-implemented services may include updating the operation of the data processing system.

A non-transitory media may include instructions that when executed by a processor cause the computer-implemented method to be performed.

A system may include the non-transitory media and a processor, and may perform the computer-implemented method when the computer instructions are executed by the processor.

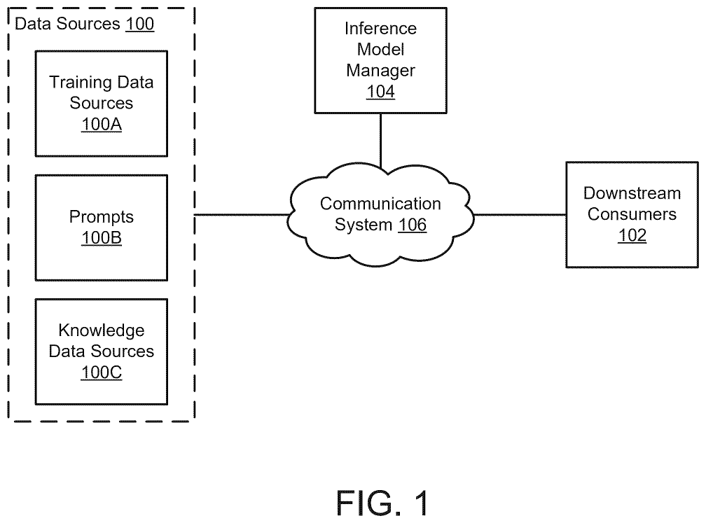

Turning to FIG. 1, a block diagram illustrating a distributed system in accordance with an embodiment is shown. The system shown in FIG. 1 may provide computer-implemented services. The computer-implemented services may include any type and quantity of computer-implemented services. For example, the computer-implemented services may include communication services, data storage services, database services, data generation services, and/or any other type of service that may be implemented with a computing device.

The computer-implemented services may be provided by data processing systems to consumers of the computer-implemented services (e.g., users of the data processing systems, other data processing systems). To provide the computer-implemented services, operation of the data processing systems may be managed, for example, in accordance with policies (e.g., security policies, acceptable use policies). The policies may be enforced via updates to the operation of the data processing system over time to increase a likelihood of providing desired (e.g., secure, reliable) computer-implemented services.

The operation of the data processing system may be managed using artificial intelligence. For example, (trained) inference models may be used to assess, predict, and/or otherwise manage occurrences of events that may negatively impact provisioning of the computer-implemented services as desired, such as security events that may threaten the security of the data processing system (e.g., sensitive data accessible using the data processing systems).

To do so, an inference model such as a generative machine-learning model may be trained to generate a response to (e.g., an inference based on) ingest data. For example, the ingest data may include information regarding programs being executed by components of a data processing system, and the inference model may be trained to identify, based on the ingest data, a security threat to the data processing system and/or actions for managing the security threat. To manage the security threat, the inference may be provided to a downstream process during which operation of the data processing system may be updated in a manner that mitigates an undesired outcome of the security threat.

However, the responses obtained from the (trained) inference models may not be reliable for managing the operation of the data processing systems if informational content of the ingest data used during inferencing is inadequate. For example, terms (e.g., words and/or phrases) included in the prompt may be ambiguous and/or may have special meaning (e.g., a term may have different meaning to an operator of the inference models than a meaning based on its dictionary definition). Therefore, to increase a likelihood of generating reliable responses during inferencing, a retrieval-augmented generation process may be implemented to improve informational content of the ingest data to the inference models. To do so, the prompt may undergo preprocessing, during which context data may be obtained for terms present in the prompt.

For example, to obtain expected quality (e.g., adequate) ingest data, the prompt may be provided to a data pipeline. The data pipeline may include a retrieval process, during which terms in the prompt are identified, and context data for the identified terms is retrieved. For example, the retrieval process may use methods to (i) identify terms present in the prompt that may require context data, (ii) identify portions of context data from a trusted data source based on the identified terms, (iii) rank the identified portions of context data, and/or (iv) select a number of the ranked identified portions of context data for use as the context data.

However, due to limitations of the retrieval process, the context data obtained during the retrieval process may not be appropriate for generating adequate ingest data to the inference models. For example, context data may not be obtained for all identified terms in the prompt, the context data may not sufficiently contextualize the terms, and/or the retrieved context data may not be relevant to the prompt.

For example, the prompt may include an indication that the inference model should generate an inference with respect to an entity. The entity may have a particularized meaning to a provider of the prompt and may include, for example, an individual, a location, a product, a service, and/or groups thereof. Therefore, to increase a likelihood of the inference model generating an inference with respect to the entity, context data used to obtain ingest data to the inference model should be relevant to the entity (e.g., and not a different entity). However, the data source searched during the retrieval process may include chunks of data relevant to different entities. For example, a first chunk of data of the data source relevant to a first entity may include different information content than a second chunk of data of the data source data relevant to a second entity.

Consequently, the context data may (i) not be sufficient for providing context for all meaningful terms present in the prompt, (ii) include data portions that are not relevant to an entity indicated by the prompt, and/or (iii) otherwise contribute to the generation of inadequate ingest data. If the ingest data is inadequate, then a subsequent inferencing process that uses the inadequate ingest data may be likely to provide unreliable inferences, and outcomes of downstream processes (e.g., management processes for the data processing systems) that use the inferences may be undesirable.

In general, embodiments disclosed herein may provide methods, systems, and/or devices for managing operation of data processing systems using inference models in a manner that is more likely to result in desirable management outcomes. To do so, prompts for processing by the inference models may be preprocessed through a data pipeline that includes an iterative context data identification process.

The context data identification process may use ontology definitions (e.g., defined by an operator of the inference models) that includes a list of ontology terms for which context data is to be retrieved when instances of the ontology terms are present in the prompt. The context data identification process may include a retrieval process during which a trusted data source is searched for context data relevant to ontology terms present in the prompt, and a filtering process during which context data is filtered based on an entity indicated by the prompt. The context data identification process may be performed iteratively until sufficiency criteria for context data relevant to the entity is met.

To improve a likelihood of retrieving relevant context data (e.g., to the entity), a filtering process may be performed to select only context data relevant to the entity. The filtering process may be performed on chunks of retrieved data after a retrieval process, or the filtering process may be performed on chunks of data of the trusted data source prior to the retrieval process.

To improve a likelihood of retrieving sufficient context data (e.g., for providing context for the ontology terms), a retrieval process may use a similarity-based search. For example, by using the similarity-based search, data chunks that are associated with an ontology term but do not include explicit mention of the ontology term may be retrieved (e.g., versus Boolean or keyword-based search methods that may require explicit mention of the ontology term in the data chunks and/or metadata thereof) from the trusted data source. However, the similarity-based search and/or corresponding ranking process may be computationally expensive when using large volumes of data, and the similarity-based search may not successfully return context data that is useful to contextualize ontology terms with respect to entities due to the manner in which the similarity-based search is performed.

Thus, to improve performance of the context data identification process (e.g., with respect to consumption of computational resources and/or computational time), different types of retrieval processes may be performed. For example, in one type of retrieval process, the retrieval process may search a filtered volume of data (e.g., a subset of a full volume of data) so that a reduced volume of data is searched during the retrieval process. The type of retrieval process may be selected depending on a likelihood of a search of the full volume of data (e.g., of the trusted data source) returning context data relevant to the entity.

For example, the type of retrieval process may be identified based on an appearance frequency for the entity with respect to chunks of data of the trusted data source. When the appearance frequency is higher than a threshold, context data may be retrieved from the trusted data source before being filtered; and when the appearance frequency is lower than the threshold, the trusted data source may be filtered before context data is retrieved from the filtered data source. The type of retrieval process may include a type that is most likely to be computationally efficient in terms of minimizing consumption of computational resources by the combination of the retrieval process and the filtering process.

By doing so, the context data obtained during prompt preprocessing may be more likely to be appropriate for providing adequate ingest data to the inference models, thereby increasing a likelihood of the inferences being reliable for use in managing the operation of the data processing systems.

To provide the above-mentioned functionality, the distributed system of FIG. 1 may include data sources 100, downstream consumers 102, inference model manager 104, and communication system 106. The distributed system, any components thereof, and/or any other types of devices or components not shown in FIG. 1 may perform all, or a portion of the computer-implemented services independently and/or cooperatively. Each of these components is discussed below.

Data sources 100 may include any type and/or number of data sources. Each of data sources 100 may include hardware and/or software components configured to obtain data, store data, provide data to other entities, and/or to perform any other tasks to facilitate performance of computer-implemented services. Different data sources of data sources 100 may facilitate similar and/or different computer-implemented services. For example, data sources 100 may include training data sources 100A, prompts 100B, knowledge data sources 100C, and/or other sources of data usable to facilitate operation of inference models.

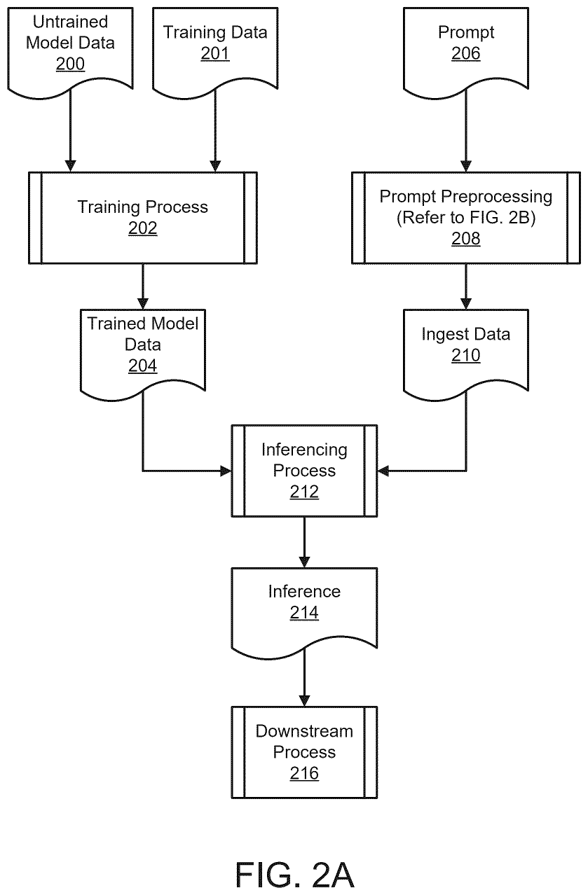

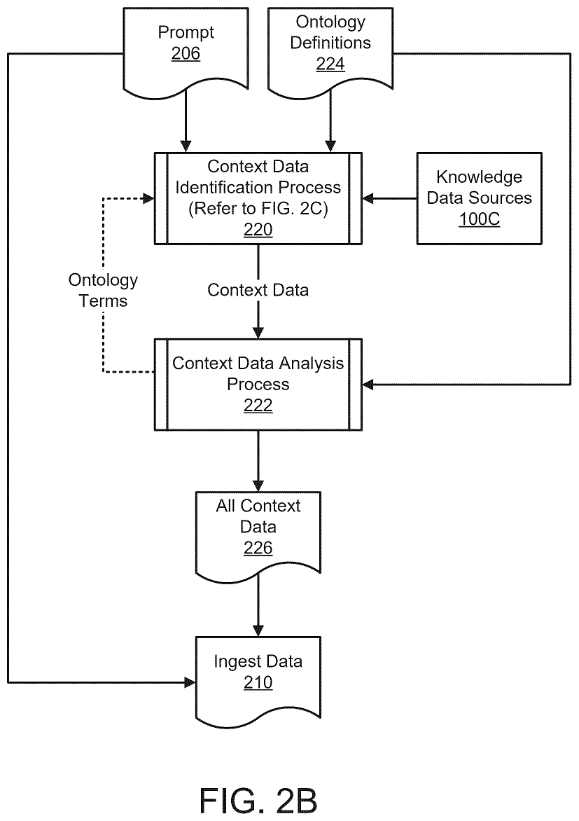

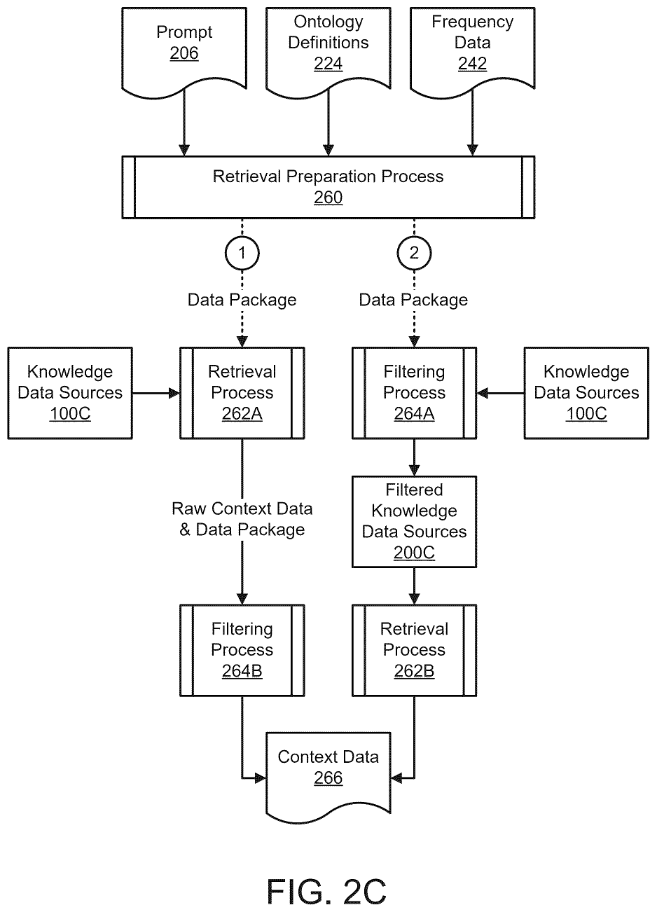

Training data sources 100A may include any number of data sources that provide training data for training of inference models. Training data sources 100A may include sources of raw data, processed data (e.g., curated data), and/or other types of data usable to train (e.g., retrain, fine-tune) the inference models. Refer to the discussion of FIG. 2A for more information regarding training of inference models.

Prompts 100B may include any volume and/or type of data for processing by the inference models. For example, prompts 100B may include any number of prompts obtained from consumers of inferences generated by the inference models (e.g., individuals, computers). Prompts 100B may include unstructured data and may be used, at least in part, to generate ingest data for inference models. For example, prompts 100B may include instances of ontology terms, and may undergo preprocessing to obtain appropriate context data for generating adequate ingest data. Refer to the discussion of FIGS. 2A-2B for more information regarding prompt preprocessing.

Knowledge data sources 100C may include any number and/or type of data sources that provide context data for prompts 100B. Knowledge data sources 100C may include a data source designated as a source of true data by an operator of inference models. Knowledge data sources 100C may be managed by the operator and/or another entity. For example, knowledge data sources 100C may include information regarding ontology terms included in ontology definitions defined by the operator and/or an organization of the operator, and may be queried during preprocessing of a prompt of prompts 100B (e.g., during a retrieval process). Refer to the discussion of FIG. 2B for more information regarding use of knowledge data sources 100C.

Data sources 100 may include data repositories (e.g., training data repositories and/or knowledge data repositories, not shown), and may provide data to (e.g., allow access to data by) inference model manager 104.

Downstream consumers 102 may include any number and/or type of downstream consumers. For example, downstream consumers 102 may include individuals, organizations, and/or computers. Downstream consumers 102 may consume all, or a portion of the computer-implemented services. For example, downstream consumers 102 may include users of the managed data processing systems.

Downstream consumers 102 may consume all, or a portion of the inferences and/or output from downstream processes that use the inferences. For example, downstream consumers 102 may generate and/or provide prompts of prompts 100B (e.g., portions of ingest data) for processing by the inference models, and may consume inferences generated by the inference models (e.g., in response to the ingest data) and/or output from the downstream processes that use the inferences. The inferences and/or output from the downstream processes may be used by downstream consumers 102 to improve decision-making and/or to automate tasks. For example, downstream consumers 102 may make decisions and/or initiate actions for managing operation of the data processing systems.

Inference model manager 104 may include any number of data processing systems and may manage any number of inference models. Inference model manager 104 may perform tasks relating to management of and/or facilitation of use of the inference models. For example, inference model manager 104 may manage (e.g., facilitate) (i) training processes for the inference models, (ii) preprocessing of prompts for the inference models, (iii) inferencing processes using the inference models (e.g., and the preprocessed prompts), (iv) downstream processes that use inferences obtained using the inference models, and/or (v) distribution of the inferences and/or output derived from the inferences to downstream consumers 102. Refer to the discussion of FIG. 2A for more details regarding operation of inference models.

To increase a likelihood of providing adequate ingest data to the inference models, inference model manager 104 may (i) obtain a prompt for an inference model (e.g., from prompts 100B), (ii) perform a context data identification process for the prompt to obtain context data that meets sufficiency criteria and that is relevant to an entity indicated by the prompt, and/or (iii) obtain ingest data based on the prompt and the context data. The context data identification process may include different types of retrieval processes. To perform the different types of retrieval processes, inference model manager 104 may perform different combinations of a retrieval process and a filtering process. The different combinations may be selected based on information regarding the entity. Refer to the discussion of FIG. 2C for more information regarding types of retrieval processes.

The context data identification process may be an iterative process. For example, to perform the context data identification process, inference model manager 104 may (i) identify ontology terms (specified by ontology definitions) for which instances of which are present in the prompt, (ii) analyze context data retrieved during a first context data identification process to identify a portion of the identified ontology terms for which the context data does not meet the sufficiency criteria, and/or (iii) perform an additional context data identification process for the portion of the identified ontology terms to retrieve additional context data that meets the sufficiency criteria. Portions of context data obtained during any of the performed context data identification processes may be packaged as context data used to obtain the ingest data for the inference model. Refer to the discussion of FIG. 2B for an example of an ontology-based iterative context data identification process.

To facilitate management of operation of the data processing systems using inference models, inference model manager 104 may (i) use the ingest data to obtain a response (e.g., an inference) from an inference model, and/or (ii) use the response to provision desired computer-implemented services (e.g., distribute the response to downstream consumers 102 and/or by provide the response to downstream processes).

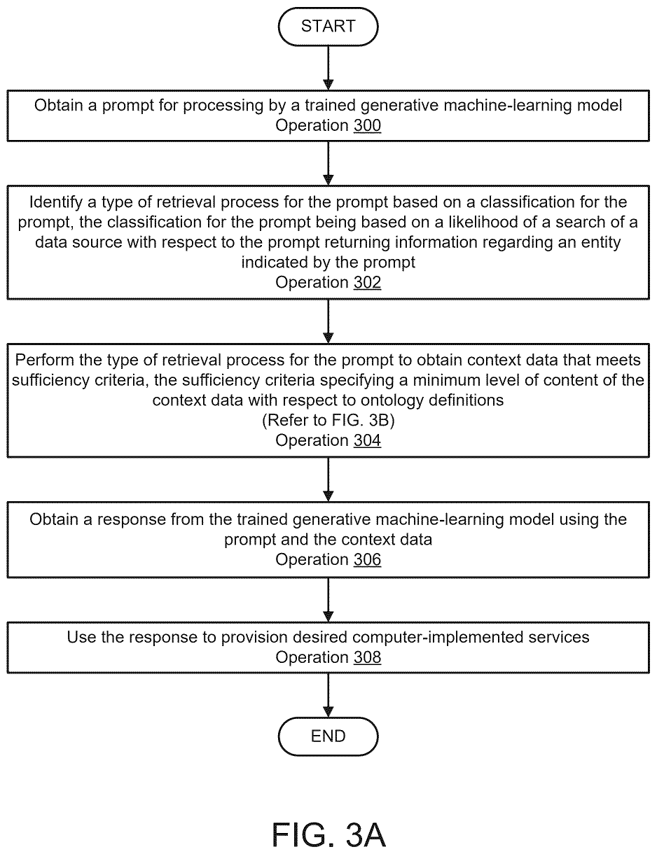

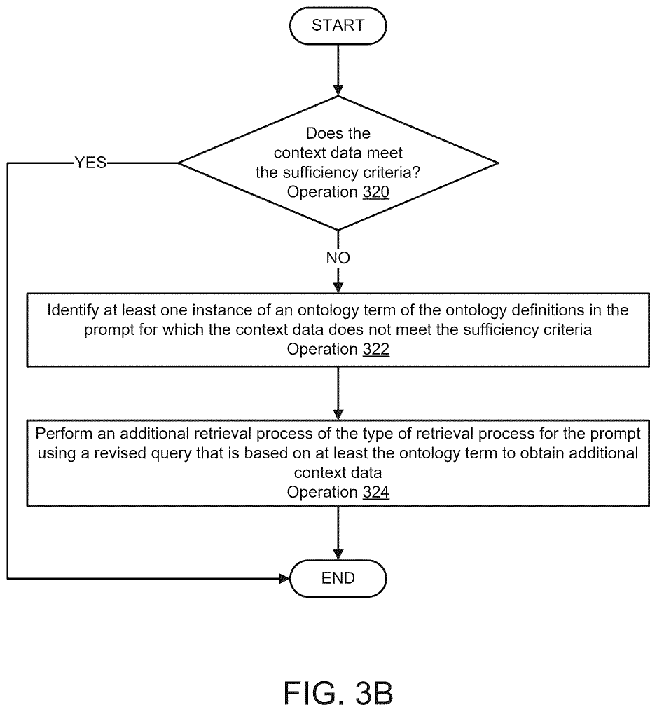

When providing their functionality, any of data sources 100, downstream consumers 102, inference model manager 104, and/or components thereof may perform all, or a portion of the actions and methods illustrated in FIGS. 2A-3B.

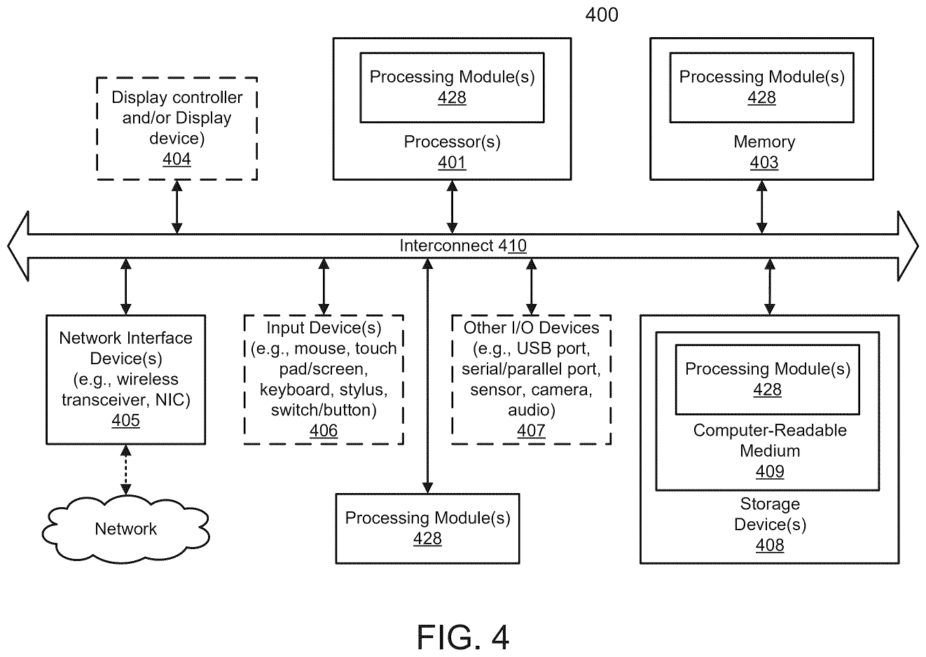

Any of data sources 100, downstream consumers 102, and inference model manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C. In the diagram, flows of data and processing of data are illustrated using different sets of shapes. A first set of shapes (e.g., 200, 201) is used to represent data structures, a second set of shapes (e.g., 202, 212) is used to represent processes performed using and/or that generate data, and a third set of shapes (e.g., 100C) is used to represent sources of data.

Turning to FIG. 2A, a first data flow diagram in accordance with an embodiment is shown. The first data flow diagram may illustrate data used in and data processing performed when facilitating operation of an inference model. For example, the inference model may be used to manage operation of a data processing system.

In the example shown in FIG. 2A, operation of the inference model may include a training process and an inferencing process. The training process may include, for example, initial training of an (untrained) inference model, retraining of an inference model, and/or fine-tuning of an inference model. The inferencing process may include, for example, obtaining inferences using a trained inference model.

To obtain a trained inference model, a management entity (e.g., inference model manager 104) may facilitate performance of training process 202. Training process 202 may include training an untrained inference model defined by untrained model data 200.

Untrained model data 200 may include information relating to model architecture, hyperparameters, and/or other information regarding an untrained inference model (e.g., optimization algorithm information, hidden layer information, bias function descriptions, activation function descriptions, etc.). An inference model type and/or size may be selected based on performance goals and/or constraints, training data availability and/or quality, budget, timeline, etc. For example, the inference model may include a probabilistic model such as a generative machine-learning model (e.g., a large language model).

During training process 202, untrained model data 200 may be updated using training data 201. Training data 201 may be obtained from any number of data sources (e.g., training data sources 100A). For example, if the inference model is being trained to manage security for a data processing system, then the training data may include a corpus of information regarding types of security threats to the data processing system, labeled with actions for responding to the types of security threats (e.g., actions for reconfiguring security settings of the data processing system accordingly). As the inference model is exposed to large numbers of relationships and/or patterns in training data 201, weights and/or other parameters of untrained model data 200 may be modified to obtain trained model data 204.

Trained model data 204 may include inference model data (e.g., information regarding the architecture and/or hyperparameters of the inference model) and/or model parameter values of the inference model (e.g., weights). Trained model data 204 may be used during an inferencing process to generate inferences in response to ingest data, such as ingest data 210.

Ingest data 210 may include a portion of data for which an inference is desired to be obtained. For example, ingest data 210 may include prompt 206 (e.g., of prompts 100B). Prompt 206 may be obtained, for example, from a consumer of inferences and may include instances of ontology terms. To obtain ingest data 210 (e.g., an enhanced version of prompt 206), prompt 206 may undergo prompt preprocessing 208. For example, during prompt preprocessing 208, context data for ontology terms present in prompt 206 may be obtained and ingest data 210 may be generated based on prompt 206 and the context data. Refer to the discussion of FIG. 2B for more details regarding prompt preprocessing and/or obtaining ingest data.

Ingest data 210, along with trained model data 204, may be provided to inferencing process 212. During inferencing process 212, a trained inference model may be obtained based on information (e.g., node information, weight information, connection information, activation functions, attention mechanisms, etc.) included in trained model data 204. Ingest data 210 may not include labeled data and, thus, an association for ingest data 210 may not be known. During inferencing process 212, the trained inference model (e.g., a trained generative machine-learning model) may read ingest data 210 and respond with an output likely to be associated with the input (e.g., the trained inference model may generate an inference).

For example, ingest data 210 may include information regarding malicious code being executed by a component of a data processing system, and inference 214 may include actions for updating security settings of the data processing system that are likely to mitigate an outcome of the execution of the malicious code according to relationships and/or patterns learned by the inference model during training process 202. Inference 214 may be used to provision computer-implemented services. For example, inference 214 may be provided to downstream process 216, and downstream process 216 may include delivery of inference 214 to a downstream consumer (e.g., as a computer-implemented service), and/or further processing of inference 214.

For example, downstream process 216 may include any type of process for updating operation of the data processing system based on inference 214. For example, downstream process 216 may include a policy enforcement process, wherein security policies for the data processing system are enforced based on information included in inference 214 (e.g., actions, security and/or configuration settings) in order to mitigate outcomes associated with the execution of the malicious code. For example, operation of the data processing system may be updated to prevent access to sensitive data, to prevent network communication via components of the data processing system, and/or to disable operation of portions of components of the data processing system.

Although described with respect to security of the data processing system, it will be appreciated that the inference models may be trained and used to update operation of the data processing system in various capacities without departing from the embodiments disclosed herein. For example, the operation of the data processing system may be updated to improve user experience, to manage failures of components of the data processing system, to improve efficient allocation of resources (e.g., computing and/or power resources), and/or to meet other operational goals for the data processing system.

Thus, using the data flows shown in FIG. 2A, operation of a data processing system may be managed based on inferences generated by trained inference models. By doing so, operation of the data processing systems may be updated timely, and the data processing systems may be more likely to operate in a desired manner.

However, a quality (e.g., usability, reliability) of the inferences generated by the trained inference models may depend on a quality of ingest data to the trained inference models. Therefore, to increase a likelihood of the ingest data being of expected quality (e.g., having adequate informational content relevant to entities indicated by the prompts), ontology terms included in prompts for the trained inference models may be contextualized. Methods for obtaining context data for the prompts may be discussed with respect to FIG. 2B.

Turning to FIG. 2B, a second data flow diagram in accordance with an embodiment is shown. The second data flow diagram may illustrate data used in and data processing performed when obtaining ingest data for an inference model. FIG. 2B may be an example of prompt preprocessing 208 of FIG. 2A.

To obtain the ingest data, context data for prompt 206 may be retrieved from knowledge data sources 100C. Prompt 206 may include a submission to be processed by a trained inference model to facilitate provisioning of desired computer-implemented services by a data processing system. For example, prompt 206 may include information regarding operation of the data processing system. Instances of at least a portion of ontology terms specified by ontology definitions 224 may be present in prompt 206.

To obtain the context data for prompt 206, context data identification process 220 may be performed. During context data identification process 220, context data may be obtained from knowledge data sources 100C based on prompt 206 and ontology definitions 224 using a retrieval process. Ontology definitions 224 may include, for example, a list (e.g., a table) of ontology terms. As discussed with respect to FIG. 1, the ontology terms may include words and/or phrases that have been designated as having a higher degree of meaning by an operator of the inference model than other words and/or phrases not designated as having the higher degree of meaning by the operator. For example, the ontology terms may include words and/or phrases that have different definitions in different subject areas.

As discussed with respect to FIG. 1, knowledge data sources 100C may include a data source designated as a source of true (e.g., trusted, reliable, relevant to a subject area) data by an operator of the inference model. For example, knowledge data sources 100C may include a number of chunks of data that are tagged to associate each of the number of chunks of data with ontology terms (and/or other searchable terms). In other words, the chunks of data may be tagged as related to the ontology terms based on relationships between informational content of the chunks and the ontology terms.

The retrieval process may include any type of process(es) wherein information (e.g., terms) present in a prompt is identified, and additional information is retrieved from a data source based on the identified information. For example, the retrieval process may implement information retrieval methods used during any type of retrieval-augmented generation process. During the retrieval process, a query may be used to search an external data source such as knowledge data sources 100C to identify responsive portions of data (e.g., chunks of context data) stored by the external data source.

The query may include, for example, search terms, search parameters, and/or other information. For example, the query may include a list of ontology terms as the search terms for which context data associated with each search term is to be retrieved from knowledge data sources 100C. The query may be derived from terms (e.g., words and/or phrases) included in the prompt (e.g., prompt 206). The query may be serviced using a deterministic process (e.g., using a trained deterministic inference model and/or any process that returns the same results for repeated servicing of the query). For example, the original may be used to identify portions of data (e.g., chunks of context data) responsive to the search terms and using the search parameters and/or instructions included in the original from the external data source (e.g., knowledge data sources 100C).

The identified portions of data responsive to the query may then be ranked for relevance using a relevance ranking algorithm (e.g., during the retrieval process and/or as a subsequent independent process). Some number (e.g., best hits) of the ranked portions of data may then be selected for use as the context data. However, due to limitations of the relevance ranking algorithm and/or selection criteria, the selected context data may lack sufficient contextual information for some terms present in the prompt such as those defined by ontology definitions 224.

Therefore, to address these limitations, context data analysis process 222 may be performed to determine whether context data obtained during context data identification process 220 meets sufficiency criteria (e.g., whether an additional iteration of context data identification process is required to obtain context data that meets the sufficiency criteria). The context data may be provided to context data analysis process 222 and may be analyzed using ontology definitions 224.

The context data obtained during context data identification process 220 may include chunks of context data that are (i) relevant to an entity indicated by prompt 206, and (ii) associated with (e.g., tagged as being associated with) a portion of ontology terms specified by ontology definitions 224 for which instances of which are identified present in prompt 206. Refer to the discussion of FIG. 2C for more details regarding obtaining context data relevant to an entity.

For example, first context data may be obtained from a first retrieval process (e.g., included in a first iteration of context data identification process 220) using an original query. Note that during the first performance of context data identification process 220, ontology terms may not be obtained from context data analysis process 222 as indicated by a respective arrow drawn in dashing.

During context data analysis process 222, the first context data may be evaluated to determine whether the first context data meets the sufficiency criteria. The sufficiency criteria may specify a minimum level of content of context data with respect to ontology definitions 224. For example, instances of ontology terms specified by ontology definitions 224 that are present in prompt 206 may be identified, and levels of content of the first context related to each instance of the ontology terms may be identified. The levels of content may be compared to the minimum level of content to identify any instances of ontology terms for which the first context data does not meet the sufficiency criteria.

For example, the minimum level of content may specify, for each ontology term of ontology definitions 224 present in prompt 206, (i) a minimum number of words related to the respective ontology terms, (ii) a minimum number of chunks of data in the first context data that are tagged as related to the respective ontology terms, and/or (iii) a combination thereof.

The sufficiency criteria for the context data may be defined by policies. For example, the policies may specify a reduced number of ontology terms present in prompt 206 that are required to satisfy the minimum level of content, and/or an increased number of terms (e.g., other ontology terms defined by ontology definitions 224, other terms not defined by ontology definitions 224) beyond the ontology terms present in prompt 206 that are required to satisfy the minimum level of content. Any instances of ontology terms identified as present in prompt 206 that are not associated with context data satisfying at least the minimum level of content may be identified during context data analysis process 222.

If the first context data meets the sufficiency criteria for all ontology terms present in prompt 206, then the first context data may be included in all context data 226. However, if at least one instance of an ontology term may be identified for which the first context data does not meet the sufficiency criteria, then at least a portion of the first context data may be included in all context data 226 (e.g., the portion of the first context data that meet the sufficiency criteria).

In a first example, the at least one instance of the ontology term (e.g., shown as “ontology terms” in FIG. 2B) having insufficient context data may be provided to context data identification process 220 to initiate an additional retrieval process (e.g., included in an additional iteration of context data identification process 220). Ontology terms for which sufficient context data has been retrieved may not be included in the ontology terms provided to the additional iteration of context data identification process 220.

In a second example, the ontology terms provided to context data identification process 220 may include all ontology terms identified in prompt 206, and each of the ontology terms may be tagged (e.g., via updating metadata) to indicate whether sufficient context data has been retrieved for each of the ontology terms. For example, the ontology term associated with the identified at least one instance may be tagged as being associated with insufficient context data, while other ontology terms may be tagged as being associated with sufficient context data.

Note that the arrow indicating the ontology terms are provided to context data identification process 220 is drawn in dashing to denote that under some conditions the ontology terms may not be provided to context data identification process 220 (e.g., such as during the first iteration of context data identification process 220 and/or during subsequent iterations of context data analysis process 222 when subsequent retrieved context data meets the sufficiency criteria for all ontology terms present in prompt 206).

During the additional iteration of context data identification process 220, a revised query may be derived using the ontology terms obtained from context data analysis process 222. For example, the revised query may only include ontology terms that are tagged as associated with insufficient context data. The revised query may include a reduced number of ontology terms specified by the ontology definitions when compared to a number of ontology terms specified by the original query (e.g., used in the first iteration of context data identification process 220).

The reduced number of ontology terms may include the ontology term (e.g., for which the at least one instance of the ontology term was identified), and may exclude a second ontology term of ontology definitions 224 for which an instance of the second ontology term is present in prompt 206 and for which the first context data meets the sufficiency criteria (e.g., the second ontology term having been included in the original query).

Consider a security example where a prompt, “Program A is being executed by component C of data processing system D, using resources Q, and is accessing file F”, is provided to a context data identification process. During a first retrieval process of the context data identification process, “A”, “C”, “D”, and “F” may include ontology terms specified by ontology definitions 224. The ontology terms may be identified based on the list of ontology terms of ontology definitions 224 and used to obtain the original query. Therefore, the original query may include 4 ontology terms specified by ontology definitions 224.

During the first retrieval process of the context data identification process, knowledge data sources 100C may return sufficient context data for “A” “C”, and “D”, but not “F”. Therefore, during context data analysis process 222, “F” may be identified as not being associated with at least the minimum level of content specified by the sufficiency criteria. Therefore, context data analysis process 222 may provide a data package including “F” (and excluding “A”, “C”, and “D”, for which sufficient context data has already been obtained) to the context data identification process, and an additional retrieval process may be performed during an additional iteration of the context data identification process. The additional retrieval process may use a revised query that includes 1 ontology term specified by ontology definitions 224 (e.g., “F”).

Returning to the additional iteration of context data identification process 220, the revised query may be used to retrieve additional context data from knowledge data sources 100C. By using the revised query, the search algorithm used during the additional retrieval process of context data identification process 220 may be more likely to rank and select sufficient context data for the ontology terms included in the revised query compared to when using the original query.

The second context data may be provided to context data analysis process 222, and a determination may be made regarding whether the second context data meets the sufficiency criteria. If the second context data meets the sufficiency criteria, then the second context data may be included in all context data 226. However, if the second context data does not meet the sufficiency criteria, then at least a portion of the second context data may be included in all context data 226, and context data analysis process 222 may be performed to identify ontology terms for which the second context data is insufficient. Iterations of context data identification process 220 and/or context data analysis process 222 may be performed until all context data 226 meets the sufficiency criteria for each instance of ontology terms present in prompt 206.

All context data 226 may include context data retrieved during any number of iterations of context data identification process 220. All context data 226 may be used, in part, to obtain ingest data 210. For example, ingest data 210 may include all context data 226 (e.g., the first context data and/or the second context data) and/or prompt 206. Ingest data 210 may be provided to an inferencing process so that a response (e.g., an inference) may be obtained using a trained inference model. For example, ingest data 210 may be provided to inferencing process 212 of FIG. 2A.

Returning to the security example, the response obtained from the inference model (e.g., inference 214 in FIG. 2A) during the inferencing process may indicate that program A is likely to include malicious code, and that file F is not expected to be accessed by program A during desired operation of data processing system D. The response may indicate that a security policy for data processing system D should be enforced (e.g., which may occur during downstream process 216 of FIG. 2A).

Turning to FIG. 2C, a third data flow diagram in accordance with an embodiment is shown. The third data flow diagram may illustrate data used in and data processing performed when obtaining context data for a prompt. FIG. 2C may be an example of context data identification process 220 of FIG. 2B.

To obtain the context data, a type of retrieval process may be identified and performed. The type of retrieval process may include a retrieval process (e.g., using a similarity-based search method) to retrieve context data associated with ontology terms, and a filtering process (e.g., using a keyword-based filtering method) to obtain context data relevant to an entity. Therefore, to obtain context data associated with the ontology terms relevant to the entity, the processes may be performed (e.g., consecutively) in a particular order. The type of retrieval process may specify the order of the processes.

The retrieval process may be more resource intensive (e.g., require more computing resources and/or computational time) than the filtering process, and resource requirements for both processes may increase (e.g., at different rates) based on an increase in a volume of data input to each process. Therefore, the type of retrieval process may be identified as the type of retrieval process that is most likely to minimize resource consumption and/or computational time by the ordered combination of the processes.

For example, if a large volume of data is filtered before performing the retrieval process, a volume of data input to the retrieval process may be reduced, thereby reducing resource consumption by the retrieval process. However, the reduction in volume of the data input to the retrieval process must be sufficient to warrant filtering the large volume of data. Therefore, the filtering process may only be performed prior to the retrieval process when the filtering process reduces the volume of data input to the retrieval process sufficiently.

To identify the type of retrieval process, retrieval preparation process 260 may be performed. During retrieval preparation process 260, an entity indicated by prompt 206 may be identified. For example, prompt 206 may be searched (e.g., using a keyword search method, using a similarity search method) to find words and/or phrases in prompt 206 that is considered similar to (e.g., based on a threshold used by the search method) an element of a list of known entities. The list of known entities may include all entities that have a particularized meaning to a provider of prompt 206. A word and/or phrase in prompt 206 that is considered similar to an element of the list of known entities may be identified as the entity.

During retrieval preparation process 260, an appearance frequency for the entity may be obtained based on frequency data 242. Frequency data 242 may include frequency data for any number of entities (e.g., all entities of the list of known entities). Frequency data 242 may indicate, for example, how often each entity appears (e.g., is mentioned explicitly) in knowledge data sources 100C (e.g., in chunks of data of knowledge data sources 100C and/or in metadata of the chunks). For example, frequency data 242 may include a database of entities and related information such as an appearance frequency for each entity, an appearance type for each entity (e.g., found in metadata, found in content), and/or other information regarding each entity.

Frequency data 242 may be obtained via an analysis of knowledge data sources 100C (not shown). For example, chunks of data of knowledge data sources 100C may be searched to obtain a number of chunks in which each entity appears, a number of chunks in which each entity does not appear, and/or a total number of chunks of knowledge data sources 100C. The numbers of chunks and/or other information may be used to obtain an appearance frequency for each entity with respect to the chunks of data of knowledge data sources 100C.

During retrieval preparation process 260, frequency data (e.g., the appearance frequency) for the entity indicated by prompt 206 may be obtained from frequency data 242 (e.g., via a database lookup, via analysis of corresponding metadata). The appearance frequency may be compared to a threshold to classify prompt 206, and the type of retrieval process to be performed for prompt 206 may be based on the classification.

The threshold may be determined (e.g., predetermined) based on (i) historical performance data of retrieval processes and/or filtering processes, (ii) a size of knowledge data sources 100C (e.g., the total number of chunks of knowledge data sources 100C), and/or (iii) other information (e.g., a quantity of available computing resources, resource scheduling information). For example, the threshold may be specified based on a likelihood of a search during a retrieval process to return information regarding the entity so that performance of a combination of the retrieval process and a filtering process using knowledge data sources 100C is optimized (e.g., resource consumption and/or computational time is minimized).

In a first example when the appearance frequency exceeds the threshold, the appearance frequency may indicate that the entity appears frequently in knowledge data sources 100C, and prompt 206 may be classified as a first classification. Since the entity appears frequently in knowledge data sources 100C, the retrieval process may be likely to return information regarding the entity when searching knowledge data sources 100C. In other words, filtering knowledge data sources 100C prior to performing the retrieval process may not reduce a volume of data input to the retrieval process sufficiently to minimize resource consumption by the combination of both processes.

In a second example when the appearance frequency does not exceed the threshold, the appearance frequency may indicate that the entity appears infrequently in knowledge data sources 100C, and prompt 206 may be classified as a second classification. Since the entity appears infrequently in knowledge data sources 100C, the retrieval process may be unlikely to return information regarding the entity when searching knowledge data sources 100C. In other words, filtering knowledge data sources 100C prior to performing the retrieval process may reduce a volume of data input to the retrieval process sufficiently to minimize resource consumption by the combination of both processes.

Thus, during retrieval preparation process 260, the type of retrieval process may be identified based on the classification of prompt 206. To prepare a data package usable to perform the type of retrieval process, prompt 206 may be analyzed. For example, prompt 206 may be analyzed to (i) identify a portion of ontology terms specified by ontology definitions 224 for which instances of the portion of the ontology terms are present in prompt 206, and/or (ii) obtain a query.

For example, using a similarity search algorithm, prompt 206 may be searched to find words and/or phrases in prompt 206 that are similar to (e.g., defined by a threshold of similarity) words and/or phrases (e.g., ontology terms) specified by ontology definitions 224. Words and/or phrases in prompt 206 that are considered similar to (e.g., within the threshold of similarity) words and/or phrases specified by ontology definitions 224 may be identified. During retrieval preparation process 260, a list of the identified ontology terms may be obtained.

The list of identified ontology terms may be used to obtain the query. For example, the query may include the list of identified ontology terms as search terms, as well as search parameters, and/or other information usable during a retrieval process. The data package obtained during retrieval preparation process 260 may include (i) information usable to perform a retrieval process (e.g., the list of identified ontology terms, the query), (ii) information usable to perform a filtering process (e.g., filtering terms and/or tags, such as the entity), and/or (iii) other information (e.g., information regarding the type of retrieval process).

Based on the type of retrieval process identified during retrieval preparation process 260, the data package may be provided to one of two streams shown in FIG. 2C (e.g., denoted by a number in a circle superimposed over arrows drawn in dashing that are descending from retrieval preparation process 260).

Returning to the first example when prompt 206 is classified as the first classification, the data package may be provided to subsequent processes via stream 1, and performing the type of retrieval process may include (i) performing a retrieval process using knowledge data sources 100C to obtain raw context data, and (ii) filtering the raw context data based on the entity to obtain context data 266.

To obtain the raw context data, retrieval process 262A may be performed. Retrieval process 262A may include any type of retrieval process and may be similar to the retrieval process described with respect to FIG. 2B. For example, during retrieval process 262A, the query (e.g., from the data package) may be used to search knowledge data sources 100C. Knowledge data sources 100C may return chunks of context data associated with search terms of the query (e.g., at least a portion of the ontology terms identified as present in prompt 206), and the chunks of context data may be ranked (e.g., by relevance to the search terms and/or other information). A portion of the ranked chunks of context data may be selected (e.g., based on a set of selection parameters) for use as the raw context data.

The raw context data may include chunks of data associated with at least the portion of the identified ontology terms; however, the raw context data may include chunks of data not relevant to the entity (e.g., relevant to other entities). To remove irrelevant chunks of data from the raw context data, the raw context data and at least a portion of the data package (e.g., the information usable to perform the filtering process) may be provided to filtering process 264B.

During filtering process 264B, the raw context data may be filtered based on the entity. Filtering process 264B may include any type of filtering process. For example, the entity may be used as a keyword for filtering, and only chunks of data of the raw context data in which the entity appears may be included in context data 266. Filtering process 264B may search metadata (e.g., for tags including the entity) of the chunks of data of the raw context data, and/or content (e.g., for explicit mention of the entity) of the chunks of data of the raw context data to identify whether the entity appears in each of the chunks of data of the raw context data. Only chunks of data of the raw context data in which the entity appears may be selected for use as context data 266. Therefore, context data 266 may include chunks of data associated with at least a portion of the identified ontology terms relevant to the entity.

Returning to the second example when prompt 206 is classified as the second classification, the data package may be provided to subsequent processes via stream 2, and performing the type of retrieval process may include (i) filtering chunks of data of knowledge data sources 100C based on the entity to obtain filtered knowledge data sources 200C, and (ii) performing a retrieval process using filtered knowledge data sources 200C to obtain context data 266.

To obtain filtered knowledge data sources 200C, filtering process 264A may use information included in the data package (e.g., the information usable to perform the filtering process) to filter the chunks of data of knowledge data sources 100C. Filtering process 264A may be similar to filtering process 264B. For example, the entity may be used to identify a portion of chunks of data of knowledge data sources 100C in which the entity appears. The identified portion of the chunks of data may be used to obtain filtered knowledge data sources 200C.

While the filtering processes (e.g., filtering process 264A, filtering process 264B) are described with respect to using a keyword search method, it will be appreciated that the filtering processes may use any type of data matching and/or filtering techniques (e.g., deterministic and/or probabilistic methods). For example, a filtering processes may use a similarity-based search method to identify chunks of data relevant to entities similar to (e.g., within a threshold of similarity) the entity used as a filtering term, and/or the filtering process may use a structured representation (e.g., a graph) of entities to identify additional filtering terms used in the filtering process.

Filtered knowledge data sources 200C may include a data structure and/or a database. For example, filtered knowledge data sources 200C may include an updated database of knowledge data sources 100C, and the updated database may include entries that are a subset of entries of knowledge data sources 100C (e.g., the subset of entries including entries that are only relevant to the entity). Thus, filtered knowledge data sources 200C may include filtered chunks of data relevant to the entity (and no other entity). Filtered knowledge data sources 200C may include (e.g., point to) a reduced volume of data (e.g., compared to knowledge data sources 100C). Therefore, data input to retrieval process 262B may be reduced, which may be likely to reduce consumption of computational resources by retrieval process 262B.

During filtering process 264A, at least a portion of the data package may be provided to retrieval process 262B (not shown). For example, the portion of the data package provided to retrieval process 262B may include the information usable to perform the retrieval process (e.g., the query).

Retrieval process 262B may be similar to retrieval process 262A and/or the retrieval process discussed with respect to FIG. 2B. For example, during retrieval process 262B, the query may be used to search filtered knowledge data sources 200C. Filtered knowledge data sources 200C may return (filtered) chunks of context data associated with search terms of the query (e.g., at least a portion of the ontology terms identified as present in prompt 206). Since filtered knowledge data sources 200C includes (filtered) chunks of data relevant to the entity only, the retrieved chunks of context data may be ranked and selected for use as context data 266. Therefore, context data 266 may include chunks of data associated with at least a portion of the identified ontology terms relevant to the entity.

While described with respect to retrieval processes (e.g., retrieval process 262A, retrieval process 262B) as including a ranking process, it will be appreciated that a ranking process may be included in and/or performed subsequent to any process described with respect to FIG. 2C. For example, chunks of context data may be ranked (e.g., reranked) after filtering process 264B and/or after retrieval process 262B to obtain (e.g., select from the ranking) context data 266.

Context data 266 may be provided to subsequent processes, such as context data analysis process 222 of FIG. 2B where context data 266 may be analyzed to determine whether context data 266 meets sufficiency criteria with respect to ontology definitions 224.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using data flows shown in FIGS. 2B-2C, a quality of ingest data to inference models may be improved using context data relevant to entities indicated by prompts submitted for processing by the inference models. In addition, performance of retrieval processes used to obtain the relevant context data may be optimized based on classifications for the prompts. The retrieval process may be performed as part of a context identification process, and the context identification process may be performed iteratively so that the retrieval processes are more likely to produce sufficient (relevant) context data for instances of ontology terms present in the prompts. By doing so, inferences obtained based on the ingest data may be more likely to be reliable for managing operation of data processing systems, and the data processing systems may be more likely provide desired computer-implemented services.

Turning to FIG. 3A, a first flow diagram illustrating a method in accordance with an embodiment is shown. The first flow diagram may illustrate various operations performed while managing operation of a data processing system.

At operation 300, a prompt for processing by a trained generative machine-learning model may be obtained. The prompt may be obtained by (i) receiving the prompt (e.g., from another device), (ii) reading the prompt (e.g., from storage), and/or (iii) generating the prompt. For example, the prompt may be generated by obtaining input from an operator (e.g., a user) of the trained generative machine-learning model and treating the input as the prompt. The prompt may indicate an entity. For example, the entity may have a particularized meaning to a provider of the prompt (e.g., the operator), and the prompt may indicate that the trained generative machine-learning model should provide a response with respect to the entity.

At operation 302, a type of retrieval process for the prompt may be identified based on a classification for the prompt. The type of retrieval process may be identified using methods described with respect to retrieval preparation process 260 of FIG. 2C and/or by other methods. The classification for the prompt may be based on a likelihood of a search of a data source with respect to the prompt returning information regarding the entity indicated by the prompt.

For example, identifying the type of retrieval process may include (i) identifying the entity indicated by the prompt, (ii) obtaining an appearance frequency for the entity with respect to chunks of data of the data source, and/or (iii) comparing the appearance frequency to a threshold to classify the prompt. The appearance frequency may indicate a likelihood of the search of the data source returning information regarding the entity.

The entity may be identified, for example, by (i) obtaining a notification indicating the entity, (ii) analyzing (e.g., searching) the prompt based on a list of known entities to identify at least one entity of the list of known entities that is same as or similar to the entity (e.g., within a threshold), and/or (iii) by other methods.

The appearance frequency may be obtained by (i) receiving the appearance frequency (e.g., from another device), (ii) reading the appearance frequency (e.g., from storage), and/or (iii) generating the appearance frequency. For example, the appearance frequency may be generated by (i) counting a number of chunks of data of the data source for which the entity is mentioned (e.g., present in metadata of each chunk of data, present in the content of each chunk of data), (ii) counting a number of chunks of data of the data source for which the entity is not present (e.g., not mentioned), and/or (iii) evaluating a function of the first number, the second number, and/or other variables (e.g., a total number of chunks of data, measures of levels of content of the chunks of data).

The appearance frequency may be compared to a threshold by evaluating whether the appearance frequency exceeds the threshold. If the appearance frequency exceeds the threshold, then the prompt may be classified as a first classification (e.g., the entity may not appear frequently in the chunks of data of the data source). If the appearance frequency does not exceed the threshold (e.g., is inferior to and/or equals the threshold), then the prompt may be classified as a second classification (e.g., the entity may appear frequently in the chunks of data of the data source).

At operation 304, the type of retrieval process for the prompt may be performed to obtain context data that meets sufficiency criteria. The type of retrieval process may be performed by methods described with respect to context data identification process 220 of FIG. 2B and/or by other methods.

For example, the type of retrieval process may be performed by (i) obtaining a query (e.g., derived based on the prompt), (ii) using the query to search (e.g., using a similarity-based search) the data source to retrieve chunks of data responsive to the query, and/or (iv) obtaining the context data based on at least a portion of the data responsive to the query. The type of retrieval process may be performed based on the classification obtained at operation 302.

In a first example when the classification is the first classification, performing the type of retrieval process may include (i) performing a retrieval process using the data source to obtain raw context data, and/or (ii) filtering the raw context data based on the entity to obtain the context data.

The retrieval process may be performed by using the query to perform a similarity-based search of the data source to identify raw context data responsive to the query. The raw context data may be filtered by (i) using a key word search (e.g., the key word being the entity) to identify portions of the raw context data associated with the entity, and (ii) treating the identified portions of the raw context data as the context data (e.g., not including other portions of the raw context data that are not associated with the entity in the context data).

In a second example when the classification is the second classification, performing the type of retrieval process may include (i) filtering the chunks of data of the data source based on the entity to obtain a filtered data source, and/or (ii) performing a retrieval process using the filtered data source to obtain the context data.

The data source may be filtered by (i) using a key word search (e.g., the key word being the entity) to identify chunks of data of the data source that are associated with the entity, and/or (ii) using the identified chunks of data to obtain the filtered data source (e.g., generating a new database for the filtered data source, updating an existing database for the data source) so that other chunks of data of the data source not associated with the entity are excluded from the filtered data source. The retrieval process may be performed by using the query to perform a similarity-based search of the filtered data source to identify context data responsive to the query.

Performing the type of retrieval process may include performing at least a portion of the operations described with respect to FIG. 3B.

Turning to FIG. 3B, a second flow diagram illustrating a method in accordance with an embodiment is shown. The second flow diagram may illustrate various operations performed while performing a type of retrieval process. The operations described with respect to FIG. 3B may be an expansion of operation 304 of FIG. 3A. For example, prior to operation 320, context data may be obtained during a retrieval process included in a context data identification process similar to context data identification process 220 of FIG. 2B.

At operation 320, a determination regarding whether the context data meets sufficiency criteria may be made. The determination may be made by methods described with respect to context data analysis process 222 and/or by other methods (e.g., obtaining a notification indicating whether the context data meets the sufficiency criteria). The sufficiency criteria may specify a minimum level of content of the context data with respect to ontology definitions. In other words, different portions of the context data may be associated with different ontology terms specified by the ontology definitions.

For example, the determination may be made by (i) identifying portions of the context data associated with each ontology term for which an instance is present in the prompt, (ii) obtaining characteristics for each of the portions of the context data (e.g., a number of words in each of the portions, a number of data chunks in each of the portions), and/or (iii) comparing the characteristics for each of the portions to a minimum level of content (e.g., a minimum number of words, a minimum number of data chunks).

If the characteristics of one or more of the portions do not meet the minimum level of content (e.g., if the number of words in a portion is inferior to the minimum number of words), then the context data may not meet the sufficiency criteria. Otherwise, if the characteristics of all of the portions meet the minimum level of content, then the context data may meet the sufficiency criteria.

In a first instance of the determination where the context data does not meet the sufficiency criteria with respect to the ontology definitions, the method may end following operation 320. Otherwise, in a second instance of the determination where the context data meets the sufficiency criteria, the method may proceed to operation 322 following operation 320.

At operation 322, at least one instance of an ontology term of the ontology definitions in the prompt for which the context data does not meet the sufficiency criteria may be identified. The at least one instance of the ontology term may be identified by methods described with respect to context data analysis process 222 and/or by other methods.

For example, the at least one instance of the ontology term may be identified by (i) obtaining a notification indicating that the context data does not meet the sufficiency criteria for the at least one instance of the ontology term, (ii) identifying a portion of the context data that does not meet the sufficiency criteria (e.g., from operation 302), and/or (iii) identifying an ontology term associated with the identified portion.

At operation 324, an additional retrieval process for the prompt may be performed using a revised query that is based on at least the ontology term to obtain additional context data. The additional retrieval process may be performed by methods described with respect to FIG. 2A, operation 302, and/or by other methods. The additional retrieval process may be performed as part of an additional context data identification process, similar to context data identification process 220 of FIG. 2B.

For example, the additional retrieval process may be performed by (i) obtaining the ontology term, (ii) obtaining (e.g., deriving) a revised query based on the ontology term, (iii) using the revised query to search the trusted data source to retrieve data responsive to the revised query, and/or (iv) obtaining additional context data based on at least a portion of the data responsive to the revised query.

As discussed with respect to FIG. 2B, subsequent retrieval processes (third, fourth, etc.) and context data analysis processes may be performed until context data obtained during the subsequent retrieval processes meets the sufficiency criteria with respect to the ontology definitions.

The method may end following operation 324.

Returning to FIG. 3A, at operation 306, a response from the trained generative machine-learning model may be obtained using the prompt and the context data. The response may be obtained by (i) receiving the response (e.g., from another device), (ii) reading the response (e.g., from storage), and/or (iii) generating the response. The response may be generated using methods described with respect to FIG. 2A and/or by other methods. For example, the response may be obtained by (i) obtaining (e.g., training) the trained generative machine-learning model, (ii) obtaining (e.g., generating) ingest data for the trained generative machine-learning model, and/or (iii) providing the ingest data to the trained generative machine-learning model for processing.

For example, in the first instance of the determination at operation 320 where the context data meets the sufficiency criteria, then the ingest data may be obtained by generating a data package that includes the prompt and the context data; or, in the second instance of the determination at operation 320 where the context data does not meet the sufficiency criteria and where a combination of the context data and additional context data (e.g., obtained during an additional iteration of the type of retrieval process, refer to the discussion of FIG. 3B) does meet the sufficiency criteria, then the ingest data may be obtained by generating a data package that includes the prompt, and the combination of the context data and the additional context data.

At operation 308, the response may be used to provision desired computer-implemented services. The response may be used by (i) providing the response to a downstream consumer as a first portion of the desired computer-implemented services, (ii) providing the response to a downstream process to obtain an output from the downstream process, and/or (iii) using the output from the downstream process to provision a second portion of the desired computer-implemented services.

Using the response may include updating the operation of the data processing system. For example, the response may include information regarding policies that should be enforced in order to increase a likelihood of providing the desired computer-implemented services in view of information included in the prompt, the context data, and/or the additional context data. Refer to the discussion of FIGS. 2A-2B for more details regarding use of the response and/or updating the data processing system.

The method may end following operation 308.

Thus, as illustrated above, embodiments disclosed herein may provide systems and methods for managing retrieval of context data ingested to an inference model used to manage operation of a data processing system.

By increasing a likelihood of retrieving sufficient and relevant context data (e.g., relevant to an entity indicated by a prompt submitted for processing by the inference model), the resulting ingest data may be more likely to facilitate reliable inferencing by the inference model.

By selecting a type of retrieval process based on a likelihood of a search of a data source returning relevant context data to the entity indicated by the prompt, performance of the retrieval process may be improved, which may reduce a quantity of computing resources and/or time required to obtain the context data and thereby the ingest data to the inference model.

As a result, the data processing system may be more likely to be updated reliably (e.g., appropriately, timely), and the computer-implemented services provided by the data processing systems may be more likely to be desired computer-implemented services.

Any of the components illustrated in FIGS. 1-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
obtaining a prompt for processing by a trained generative machine-learning model;
identifying a type of retrieval process for the prompt based on a classification for the prompt, the classification for the prompt being based on a likelihood of a search of a data source with respect to the prompt returning information regarding an entity indicated by the prompt;
performing the type of retrieval process for the prompt to obtain context data that meets sufficiency criteria, the sufficiency criteria specifying a minimum level of content of the context data with respect to ontology definitions;
obtaining a response from the trained generative machine-learning model using the prompt and the context data; and
using the response to provision desired computer-implemented services.

2. The method of claim 1, wherein identifying the type of retrieval process comprises:
identifying the entity indicated by the prompt;
obtaining an appearance frequency for the entity with respect to chunks of data of the data source; and
comparing the appearance frequency to a threshold to classify the prompt.

3. The method of claim 2, wherein the entity, as indicated by the prompt, has a particularized meaning to a provider of the prompt, and the prompt indicating that the response should be provided with respect to the entity.

4. The method of claim 2, wherein when the classification is a first classification, performing the type of retrieval process comprises:
performing a retrieval process using the data source to obtain raw context data; and
filtering the raw context data based on the entity to obtain the context data.

5. The method of claim 4, wherein when the classification is a second classification, performing the type of retrieval process comprises:
filtering the chunks of data of the data source based on the entity to obtain a filtered data source; and
performing a retrieval process using the filtered data source to obtain the context data.

6. The method of claim 1, wherein the search of the data source with respect to the prompt comprises a similarity-based search of chunks of data of the data source.

7. The method of claim 1, wherein performing the type of retrieval process comprises:
making a determination regarding whether the context data meets the sufficiency criteria; and
in a first instance of the determination where the context data does not meet the sufficiency criteria:
identifying at least one instance of an ontology term of the ontology definitions in the prompt for which the context data does not meet the sufficiency criteria, and
performing an additional retrieval process of the type of retrieval process for the prompt using a revised query that is based on at least the ontology term to obtain additional context data.

8. The method of claim 1, wherein the ontology definitions comprises a list of ontology terms, and the ontology terms are words and/or phrases that have been designated as having a higher degree of meaning by an operator of the trained generative machine-learning model than other words and/or phrases not designated as having the higher degree of meaning by the operator.

9. The method of claim 8, wherein the data source is designated as a source of true data by an operator of the trained generative machine-learning model, and the data source comprises a number of chunks of data that are each tagged to associate each of the number of chunks of data with the ontology terms.

10. The method of claim 1, wherein using the response to provision the desired computer-implemented services comprises:
updating the operation of the data processing system.

11. A non-transitory machine-readable medium having instructions stored therein, which when executed by a processor, cause the processor to perform operations for managing operation of a data processing system, the operations comprising:
obtaining a prompt for processing by a trained generative machine-learning model;
identifying a type of retrieval process for the prompt based on a classification for the prompt, the classification for the prompt being based on a likelihood of a search of a data source with respect to the prompt returning information regarding an
entity indicated by the prompt;
performing the type of retrieval process for the prompt to obtain context data that meets sufficiency criteria, the sufficiency criteria specifying a minimum level of content of the context data with respect to ontology definitions;
obtaining a response from the trained generative machine-learning model using the prompt and the context data; and
using the response to provision desired computer-implemented services.

12. The non-transitory machine-readable medium of claim 11, wherein identifying the type of retrieval process comprises:
identifying the entity indicated by the prompt;
obtaining an appearance frequency for the entity with respect to chunks of data of the data source; and
comparing the appearance frequency to a threshold to classify the prompt.

13. The non-transitory machine-readable medium of claim 12, wherein the entity, as indicated by the prompt, has a particularized meaning to a provider of the prompt, and the prompt indicating that the response should be provided with respect to the entity.

14. The non-transitory machine-readable medium of claim 12, wherein when the classification is a first classification, performing the type of retrieval process comprises:
performing a retrieval process using the data source to obtain raw context data; and
filtering the raw context data based on the entity to obtain the context data.

15. The non-transitory machine-readable medium of claim 14, wherein when the classification is a second classification, performing the type of retrieval process comprises:
filtering the chunks of data of the data source based on the entity to obtain a filtered data source; and
performing a retrieval process using the filtered data source to obtain the context data.

16. A system, comprising:
a processor; and
a memory coupled to the processor to store instructions, which when executed by the processor, cause operations for managing operation of a data processing system to be performed, the operations comprising:
obtaining a prompt for processing by a trained generative machine-learning model,
identifying a type of retrieval process for the prompt based on a classification for the prompt, the classification for the prompt being based on a likelihood of a search of a data source with respect to the prompt returning information regarding an entity indicated by the prompt,
performing the type of retrieval process for the prompt to obtain context data that meets sufficiency criteria, the sufficiency criteria specifying a minimum level of content of the context data with respect to ontology definitions,
obtaining a response from the trained generative machine-learning model using the prompt and the context data, and
using the response to provision desired computer-implemented services.

17. The system of claim 16, wherein identifying the type of retrieval process comprises:
identifying the entity indicated by the prompt;
obtaining an appearance frequency for the entity with respect to chunks of data of the data source; and
comparing the appearance frequency to a threshold to classify the prompt.

18. The system of claim 17, wherein the entity, as indicated by the prompt, has a particularized meaning to a provider of the prompt, and the prompt indicating that the response should be provided with respect to the entity.

19. The system of claim 17, wherein when the classification is a first classification, performing the type of retrieval process comprises:
performing a retrieval process using the data source to obtain raw context data; and
filtering the raw context data based on the entity to obtain the context data.

20. The system of claim 19, wherein when the classification is a second classification, performing the type of retrieval process comprises:
filtering the chunks of data of the data source based on the entity to obtain a filtered data source; and
performing a retrieval process using the filtered data source to obtain the context data.
